(19) United States
(12) Patent Application Publication
(10) Pub. No.: US 2025/0343284 A1
(43) Pub. Date: Nov. 6, 2025

(54) IMPROVED COMMUNICATION DEVICE FOR BATTERY PACKS

(71) Applicant: DUKOSI LIMITED, Edinburgh (GB)

(72) Inventors: Joel SYLVESTER, Edinburgh (GB); Daniel DECLE COLIN, Edinburgh (GB)

(21) Appl. No.: 18/870,263

(22) PCT Filed: May 26, 2023
(86) PCT No.: PCT/EP2023/064293

§ 371 Date: Nov. 27, 2024

(30) Foreign Application Priority Data
May 29, 2022 (GB) 2207924.8

(51) Int. Cl. H01M 10/42; H01M 10/48; H01Q 9/04; H04B 1/40

(52) U.S. Cl. CPC H01M 10/425; H01Q 9/045; H01M 2010/4271; H01M 2010/4278; H01M 10/482; H04B 1/40

(57) ABSTRACT

An assembly is provided for use with a battery pack comprising a plurality of battery cells. The assembly enables communication between an electronic device and a radio transceiver located remotely from the electronic device. The assembly comprises: a module antenna operatively connected to the electronic device, the module antenna comprising a transmission line having a first and a second section arranged in series forming an unbalanced electrical path, the first and second sections being of equal electrical length, and a total path length of the first and second sections is an integer-multiple of half an operating wavelength of a carrier wave; a bus antenna configured for operative communication with the radio transceiver, the bus antenna comprising at least two transmission lines, each transmission line being greater in length than either the first or second section of the module antenna, and each one of the transmission lines being spaced apart from and positioned adjacent to a different one of the first and second sections of the module antenna's transmission line, to enable near-field coupling between the module antenna and the bus antenna when a transmission signal is input into either the module antenna or the bus antenna.

### TECHNICAL FIELD

The present disclosure relates to the field of batteries and battery cells. Embodiments of the disclosure relate to assemblies for use with battery packs comprising a plurality of battery cells, the assemblies enabling wireless communication between electronic devices within the battery packs and a battery management system (BMS) comprising a radio transceiver located remotely from the electronic device.

### BACKGROUND

Battery systems, comprising a plurality of battery cells, are used in a wide variety of modern electric power applications. For example, they are used to power electric vehicles, they are used in industrial power applications, in transportation, and commercial applications such as powering of modern electronic devices. Given the relatively high-power demands of such applications, a battery system often comprises a plurality of battery cells coupled together to achieve the required power and/or voltage output. The battery cells may be coupled together to form a battery pack, and the battery system may comprise one or more battery packs.

It is common practice to connect a battery system to a battery management system (BMS) which is configured to ensure that the battery system operates within its safe operating range. The safe operating range is defined as the temperature, voltage, and current conditions under which the battery system is expected to operate without self-damage. A BMS may include one or more Cell Monitoring Devices (CMDs) configured to monitor at least one battery cell and report back to the BMS. A CMD typically consists of an electronic device that may be configured to measure physical characteristics at the battery cell level, such as current, voltage, temperature, and other characteristics useful in determining the condition of a battery cell.

As a result, BMS's typically include communication means between each CMD and the management circuitry of the BMS. However, given the high-voltage environment in which BMS's and the CMD's are deployed, to ensure fault-free operation, it is necessary to ensure that such systems provide high voltage isolation and EMI (electromagnetic interference) immunity performance. High voltage isolation is required in respect of communication signals transmitted between individual battery cells or packs and the BMS, because each battery cell or pack sits at different voltages relative to the system ground. The voltage variation from the system ground can reach hundreds of volts in a typical battery system. Therefore, kilovolt isolation may be required. Additionally, electromagnetic interference can couple with the communication signals transmitted between the CMDs and the BMS, disrupting the communication signal or directly interfering with it. Since high-voltage battery systems are strong sources of EMI, the immunity performance of a communication system deployed within a battery pack is important.

Known applications to signal communication within a battery system, include isolated wired communication protocols such as CAN bus, or wireless communication protocols such as WiFi or ZigBee. Although both approaches address the isolation problem, wired communication protocols do not directly address the EMI problem, and require more cumbersome assembly. The use of WiFi or ZigBee, which involves the use of far-field communication protocols, require that each antenna in the battery system be separated by a plurality of wavelengths at which the radio frequency operates, in order to function optimally. These solutions may not fit the typical dimensions of many battery systems.

It is an object of at least some embodiments of the present disclosure to address one or more of the shortcomings of the prior art and, in particular, to provide a more convenient means for enabling communication with a BMS within a battery system, which benefits from high voltage isolation, and electromagnetic interference immunity.

### SUMMARY

In accordance with an aspect of the disclosure, there is provided an assembly for use with a battery pack comprising a plurality of battery cells, the assembly being suitable for enabling communication between an electronic device and a radio transceiver located remotely from the electronic device. The assembly may comprise: a module antenna operatively connected to the electronic device, the module antenna comprising a transmission line having a first and a second section arranged in series forming an unbalanced electrical path, the first and second sections being of equal electrical length, and a total path length of the first and second sections is an integer-multiple of half an operating wavelength of a carrier wave; a bus antenna configured in use to provide a communication channel for the radio transceiver, the bus antenna comprising at least two transmission lines, each transmission line being greater in length than either the first or second section of the module antenna, and each one of the transmission lines being spaced apart from and positioned adjacent to a different one of the first and second sections of the module antenna's transmission line, to enable near-field coupling between the module antenna and the bus antenna when a transmission signal is input into either the module antenna or the bus antenna. The total path length of the first and second sections of the module antenna transmission line may be half an operating wavelength of the carrier wave. In operation, the module antenna and the bus antenna may form a balun, and wherein when the transmission signal comprises an unbalanced electrical signal input in the module antenna, it may be output as a balanced electrical signal in the bus antenna. Or, when the transmission signal comprises a balanced electrical signal input in the bus antenna, it may be output as an unbalanced electrical signal in the module antenna.

In accordance with other aspects of the disclosure, there are provided a battery cell comprising the aforementioned assembly, and a battery pack having a plurality of battery cells comprising the aforementioned assembly.

### BRIEF DESCRIPTION OF THE DRAWINGS

Specific embodiments of the disclosure will be described in more detail below with reference to the accompanying drawings, in which like-numbered reference numerals appearing in different drawings, refer to the same components and/or steps. The drawings are not drawn to scale.

FIG. 1 is a schematic illustration of a battery system, in accordance with an embodiment of the disclosure.

FIG. 2A is a schematic illustration of an exemplary balanced circuit using common mode rejection.

FIG. 2B is a schematic illustration of the balanced circuit of FIG. 2A comprising baluns.

FIG. 3 represents a schematic illustration of an exemplary bus/module antenna assembly, wherein the first and second sections of the module antenna are aligned, in accordance with an embodiment of the present disclosure.

FIG. 4 represents a schematic illustration of an exemplary bus/module antenna assembly, wherein the module antenna is U-shaped and connected to a termination resistor, in accordance with an embodiment of the present disclosure.

FIG. 5 represents a schematic illustration of an exemplary bus/module antenna assembly, wherein the first and second sections of the module antenna are aligned, in accordance with an embodiment of the present disclosure.

FIG. 6A is a perspective view of a printed circuit board comprising the module antenna and the electronic device in accordance with an embodiment of the present disclosure.

FIG. 6B is a top view of the printed circuit board illustrated in FIG. 6A.

FIG. 6C is a side view of the printed circuit board illustrated in FIGS. 6A and 6B.

FIG. 7A is a perspective view of a printed circuit board comprising a module antenna, electronic device, and a bus antenna, wherein the module antenna and the bus antenna are fixated to an exterior surface of a printed circuit board, in accordance with an embodiment of the present disclosure.

FIG. 7B is a top view of the printed circuit board of FIG. 7A.

FIG. 7C is a side view of the printed circuit board of FIGS. 7A and 7B.

FIG. 8A is a top view of a printed circuit board comprising a module antenna, electronic device, and bus antenna, and wherein the module antenna is embedded within a layer of a printed circuit board, and the bus antenna is fixated to an exterior surface of the printed circuit board, in accordance with an embodiment of the present disclosure.

FIG. 8B is a side view of the printed circuit board of FIG. 8A.

FIG. 9A is a top view of a first and second printed circuit board separated by an air gap, the first printed circuit board comprising a module antenna and electronic device, and the second printed circuit board comprises a bus antenna, in accordance with an embodiment of the present disclosure.

FIG. 9B is a side view of the printed circuit board of FIG. 9A.

FIG. 10A is a top view of a printed circuit board and a bus antenna, the printed circuit board comprising a module antenna and an electronic device, and the bus antenna comprising a cable external to the printed circuit board, in accordance with an embodiment of the present disclosure.

FIG. 10B is a side view of the printed circuit board of FIG. 10A.

FIG. 11 is a top view of a printed circuit board and a bus antenna, the printed circuit board comprising a module antenna having an hourglass form, and wherein the bus antenna comprises a cable, having at least two conductors, external to the printed circuit board, in accordance with an embodiment of the present disclosure.

### DETAILED DESCRIPTION

Exemplary embodiments of the disclosure will now be described with reference to the accompanying drawings. The same reference numerals used in different drawings represent the same or similar elements unless otherwise stated. The below-described exemplary embodiments do not represent all envisaged implementations of the disclosure. Instead, they are merely non-limiting examples consistent with aspects of the disclosure as recited in the appended claims.

Embodiments of the present disclosure provide an assembly comprising an electronic device and module antenna configured local to a battery module, which enable wireless, near-field communication with a bus antenna. The bus antenna provides a signal path to a battery management system (BMS) located remotely from the battery module. Near-field communication with the bus antenna is achieved through electro-magnetic coupling between the module antenna and the bus antenna. The module antenna itself may comprise a transmission line having a first and a second section arranged in series, which enable electro-magnetic coupling with the bus antenna. Embodiments of the present disclosure therefore provide a convenient solution for achieving near-field communication within a battery system, which can accommodate a wide range of different implementations of battery modules within a battery system. Further details follow below, along with an explanation of the underlying principles of operation.

### Battery Management System (BMS) Overview

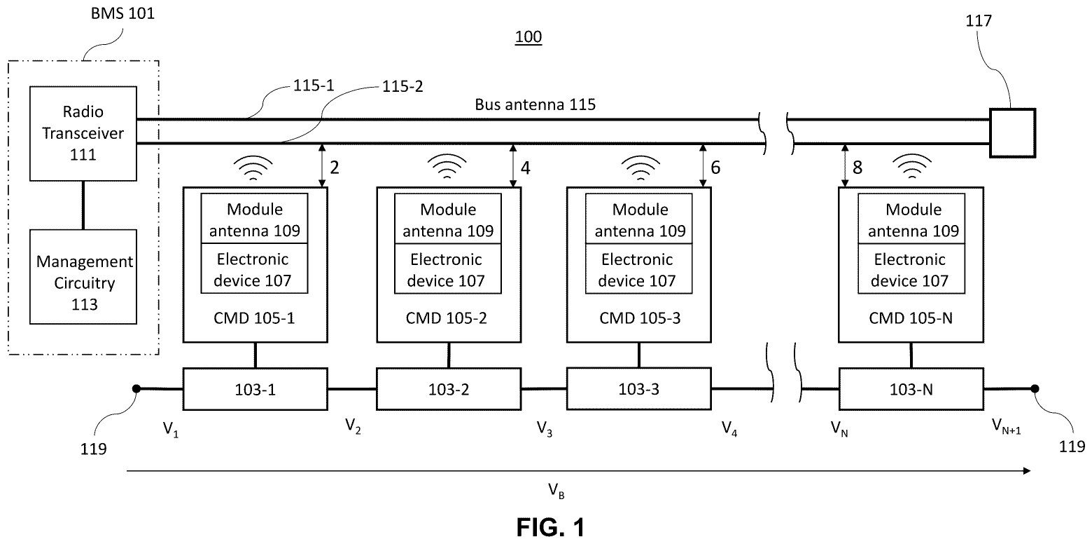

FIG. 1 is a schematic illustration of a battery system 100 in accordance with embodiments of the present disclosure. Battery system 100 comprises, but is not limited to, a plurality of battery modules 103 (labelled with an integer between 1 and N, where N is the total number of battery modules in battery system 100) a BMS 101, one or more cell monitoring devices (CMD) 105, and a bus antenna 115. In accordance with the illustrated embodiment, each battery module 103 is monitored by an associated CMD 105 (labelled with an integer in relation to the associated battery module). In alternative embodiments, each single CMD may monitor one or more different battery modules. Battery modules 103 of battery system 100 may be electrically coupled, and battery system 100 may include electrical terminals 119 for drawing electrical power from battery system 100. Battery modules 103 may comprise a single battery cell or a plurality of battery cells arranged in series, in parallel or a combination thereof. In the illustrated embodiment of FIG. 1, each CMD 105 may be configured to communicate (transmit/receive data) with BMS 101, and more specifically with BMS management circuitry 113, by near field coupling (NFC) with bus antenna 115. Bus antenna 115 may be connected to radio transceiver 111, which is itself connected to management circuitry 113 of BMS 101.

Each CMD 105 may comprise electronic device 107 and module antenna 109. Electronic device 107 may comprise, or be operatively connected to, a plurality of sensors configured to measure and monitor one or more physical characteristics (e.g. voltage, current, charge, temperature, pressure, humidity) at the battery module level or the battery cell level. Module antenna 109 may relate to any physical system capable of establishing NFC communication with bus antenna 115. Accordingly, module antenna 109 and bus antenna 115 enable communication between each electronic device 107 of each CMD 105 and radio transceiver 111, located remotely from the plurality of electronic devices 107.

In the present context, near-field coupling may be interpreted as involving a distance of separation between bus antenna 115 and each module antenna 109 of less than one wavelength of electromagnetic radiation, and more specifically less than one wavelength of the radio wave transmission signal between bus antenna 115 and module antenna 109. For example, the distance of separation may be less than 120 mm, when the wavelength is 120 mm. Stronger electromagnetic near-field coupling may occur when the separation is substantially less than one wavelength, for example, less than one-tenth of a wavelength. Battery system 100 may be configured so that each module antenna 109 is spaced from the transmission line by no more than one-half, one-third, one-quarter, one-fifth, one-sixth, one-seventh, one-eighth, one-ninth or one-tenth of the wavelength of the electromagnetic radiation. In accordance with some embodiments, the wavelength of the transmission signal may relate to any Industrial Scientific Medical (ISM) short-range radio band. Exemplary, non-limiting wavelengths may comprise 440 MHz, 828 MHz, 915 MHz, 2.4-2.5 GHz, and 5 GHz.

The use of near-field coupling may allow the plurality of module antennas 109 to be positioned close to the bus antenna 115, and module antennas 109 are less sensitive to external EMI interference than the far-field module antennas of the prior art, thereby overcoming some of the problems described above. In accordance with some embodiments, the plurality of module antennas 109 may be arranged at substantially the same distance from bus antenna 115. The transmission of communication between electronic devices 107 and radio transceiver 111 may be subject to additional constraints arising as a result of the high-voltage environment of battery system 100. As mentioned previously, these additional constraints relate to: high voltage isolation and immunity to electromagnetic interference. These two constraints are described below.

### High-Voltage Isolation

Battery system operating voltages (V_{B}) are obtained by stacking different cells or battery packs in series (as shown in FIG. 1). For most applications, these operating voltages are considered, although definitions may differ, as high voltages (V_{B}>60 V). For example, automotive batteries typically have an operating voltage of about 400 V, buses may operate at 800V, and industrial energy storage systems may operate at 1500V. As shown in FIG. 1, each battery module 103 experiences a different voltage/potential difference Vᵢ₊₁−Vᵢ (with i an integer between 1 and N) relative to the ground of battery system 100, with each Vᵢ increasing progressively. It follows that the last battery module 103-N in battery system 100 is at a higher voltage than first battery module 103-1. It may be necessary to isolate these high voltages to prevent devices within the battery system from experiencing them, that may otherwise not be able to withstand such high voltages. In particular, high-voltage isolation is required between the antenna module 109 and bus antenna 115. In FIG. 1 module antenna 109 and bus antenna 115 are separated by gaps 2, 4, 6, 8. It follows from the preceding discussion regarding the voltage each different battery module 103 experiences, that the high-voltage isolation required across gaps 2, 4, 6, 8 may in principle be different for different battery modules 103, subject to the voltage each battery module 103 is subject to. Thus, for example, the high-voltage isolation required across gap 2, between module antenna 109 of battery module 103-1 and bus antenna 115, may be less than the high-voltage isolation required across gap 8, between the module antenna 109 of battery module 103-N and bus antenna 115, since battery module 103-N may be at a higher voltage relative to battery module 103-1. Thus, a battery system 100 in which different battery modules have a different high-voltage isolation is envisaged. However, for practical purposes, it is often easier to configure each battery module 103, associated module antenna 109 and gap 2, 4, 6, 8 to satisfy the maximum high-voltage isolation that may be experienced within the battery system 100. In other words, each battery module, and more specifically the associated module antenna 109 and gap 2, 4, 6, 8, may be configured to ensure high-voltage isolation for the maximum voltage that battery module 103-N may experience.

Consider an automotive battery consisting of 96 lithium polymer cells with a maximum voltage of 4.2 V. The maximum operating voltage V_{B} of such an automotive battery is therefore 403.2 V. The automotive battery may be divided into 8 battery modules of 12 cells connected in series, each with a voltage of 50.4 V. A CMD configured to handle 60 V is therefore capable of monitoring 12 cells, but as battery packs are connected in series, each subsequent CMD should be electrically isolated from all others CMDs and associated battery modules, and in particular should be isolated from experiencing the automotive battery operating voltage V_{B}, to ensure that the maximum potential difference observed by a single CMD is less than 60 V. If two battery packs are not perfectly isolated, their respective CMD may not withstand the potential difference (of 100.8 V).

High voltage isolation requires using the correct isolation components with the proper materials, but also adherence to the correct distances in the design of the battery system to ensure that high voltage insulation is maintained in all use cases, in all environments and as the battery system ages. Two characteristic distances associated with the geometry of a battery system are decisive for ensuring high voltage isolation: clearance distance, and creepage distance. The clearance distance (IEC 60664-1) corresponds to the shortest distance in air between two conductive parts, whereas the creepage distance (IEC 60664-1) corresponds to the shortest distance along the surface of a solid insulating material between two conductive parts. To ensure a specific level of voltage isolation between two conductive parts, a specific minimum clearage/creepage distance needs to be observed. These distances are generally specified in industry standards documentation, an example of which is IEC standard 60664-1. In practice, a voltage isolation level greater than the battery operating voltage V_{B} may be selected, e.g. for a 400 V battery system, a voltage isolation level of 500 V, 1 kV or more may be appropriate.

It should be noted that high voltages represent not only a risk of damage to battery system componentry, but also present a risk of electric shock to an assembly operator or end user of the battery system. The components used for signal communication between CMDs, battery modules, and the BMS within a battery system, are closely monitored as they present potential sources of current leakage, and the associated risks increase with the increasing number of cells N.

### Electromagnetic-Interference Immunity and Common Mode Rejection

Electromagnetic interference (EMI) is the disturbance of electronic equipment or systems by electromagnetic radiation, electrostatic coupling, magnetic coupling or electrical conduction. It can cause malfunction, data corruption, data loss or even complete failure of the affected equipment. EMI may be caused by a variety of different sources, including power lines, radio waves and even household appliances. Within the context of a battery system, the high voltages and currents present, are strong sources of EMI, and electronic components such as CMDs or other circuitries are susceptible to EMI. Shielding, filtering, and grounding are common methods used to reduce the effects of EMI on electronic systems.

In accordance with embodiments of the disclosure, the approach taken to reduce EMI resides in the use of balanced electrical paths and common mode rejection. For an electrical signal to propagate, there must be a return path. In an unbalanced system, a first conductor is provided to propagate a signal, and the return path is referred to as the ground connection. In a balanced system, a second conductor is provided to propagate the same signal as the first conductor, but with opposite polarity (e.g. same magnitude, but opposite phase). The second conductor is the return path for the first conductor, and vice versa.

In a balanced system, there are two modes of signal propagation. The first mode is differential, where the signal of interest is determined by the difference in signals propagating on the two conductors. The second mode is common mode, where the signal of interest is the signal that appears on both conductors. In a balanced system, EMI is usually coupled to the common mode, and noise filtering may be required to remove it. In contrast, when operating in differential mode, the signals are of opposite polarity, and the output is determined by calculating the difference of the two opposite polarity signals propagating on each conductor. Any EMI which couples to the two conductors may effectively be removed or filtered out, when the signal difference is determined. The magnitude and polarity of the induced EMI in each conductor is essentially the same, since the two conductors are located close together relative to the distance of the source causing the EMI. Thus, when the difference of the two EMI noise affected signals propagating in the two conductors is determined, the induced EMI noise cancels. In this way, a desired signal may be transmitted without traces of EMI in the differential mode conductor. In practice, determining the difference of the opposite polarity two signals propagating on the two conductors may require a signal subtractor. In other words, a device that receives as its input the two differential signals, and outputs their difference, which is the signal of interest. A differential receiver may be used to determine the difference. Similarly, differential amplifier is another example of a signal subtractor, albeit the differential amplifier outputs an amplified difference signal. Conversely, generating differential signal for input to two conductors may require a differential output block such as an input signal splitter and inverter, a differential output amplifier or a phase splitter. The signal splitter separates an input signal V_{dm} into two equal magnitude signals V_{dm}/2. The inverter inverts the polarity of one of the split signals (i.e. −V_{dm}/2). The end result is that two signals of opposite polarity are provided (i.e. equal magnitude but opposite phase), that may be input on separate conductors, thus forming a differential pair of signals. Functionally, the splitter-inverter performs the inverse of the subtractor—provided with a single input signal, it splits it into two signals and inverts the polarity of one of them. In contrast, the subtractor provided with a differential pair of signals, determines the difference by subtracting the two differential signals to output the difference signal.

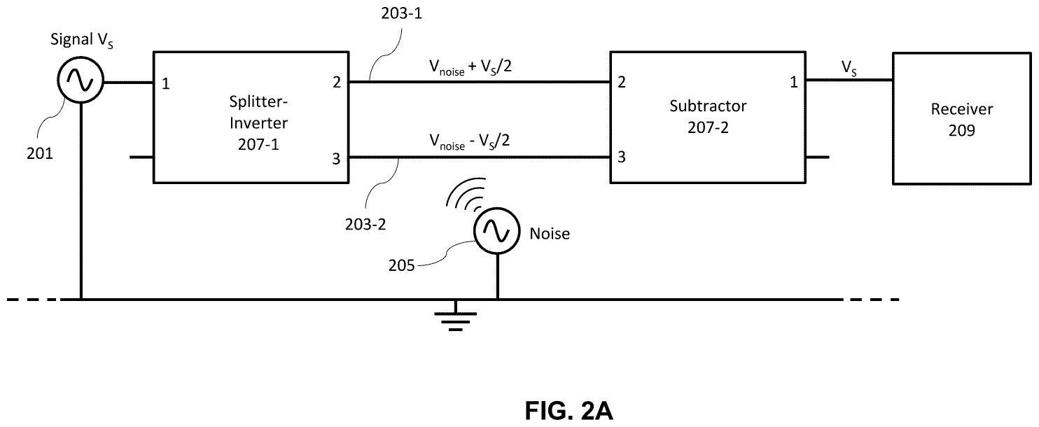

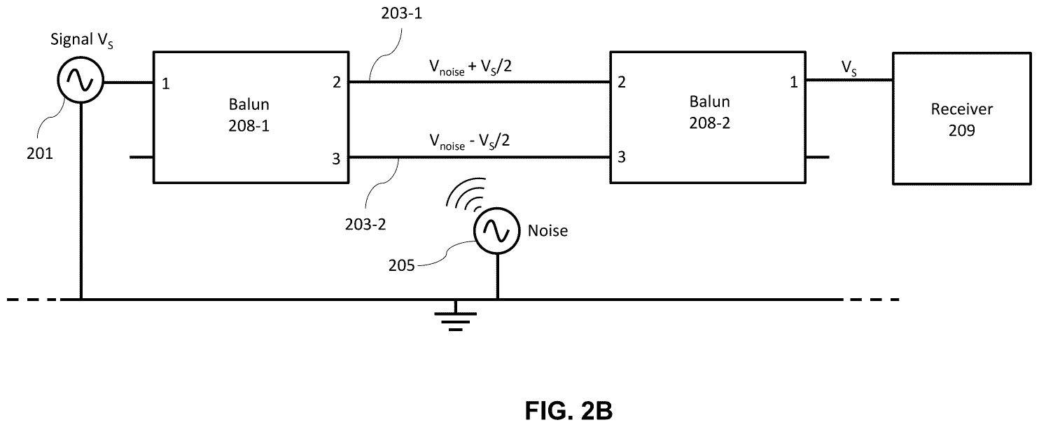

FIG. 2A is a schematic illustration of an exemplary balanced circuit using common mode rejection. A signal source 201 provides an input signal V_{S} to be transmitted to a receiver 209. The circuit comprises a first 203-1 and second 203-2 balanced conductor. Differential signals V_{S}/2 and −V_{S}/2 are generated using splitter-inverter 207-1, for input signal V_{S}. First differential signal V_{S}/2 is output to first conductor 203-1 and second (inverted) differential signal −V_{S}/2 is output to second conductor 203-2. If the circuit is not perfectly immune to EMI, both first 203-1 and second 203-2 conductors may experience an interference/noise signal Vₙₒᵢₛₑ from a nearby noise source 205. However, because both conductors are balanced, the resulting signal propagating along first conductor 203-1 is equal to Vₙₒᵢₛₑ+V_{S}/2, and that on second conductor 203-2 is equal to Vₙₒᵢₛₑ−V_{S}/2. The two resulting signals are input to subtractor 207-2, where the difference signal is output from subtractor 207-2 and input to receiver 209. Thus, at the receiver 209, a signal proportional to the difference between the two resulting signals from first 203-1 and second 203-2 conductors is measured, i.e., Vₙₒᵢₛₑ+V_{S}/2−Vₙₒᵢₛₑ−(−V_{S}/2)=V_{S}. The common mode interference/noise signal Vₙₒᵢₛₑ has been removed. As mentioned previously, the function of the subtractor 207-2 may be provided by a differential amplifier, in which case the output signal received at the receiver 209 is amplified, i.e. GV_{S}, where G represents the gain of the differential amplifier. The measure of a differential amplifier's ability to eliminate common-mode voltage is known as the common-mode rejection ratio, or CMRR.

The differential operations on the first 203-1 and second 203-2 conductor signals may be performed using baluns 208, as illustrated in FIG. 2B. In other words, in accordance with some embodiments, the function of splitter-inverter 207-1 and subtractor 207-2 of FIG. 2A may be provided by baluns 208. Baluns 208 are reciprocal three-port power splitters comprising one unbalanced port and two balanced ports, illustrated respectively in FIG. 2B as port 1 and ports 2 and 3. Signals at the balanced ports are equal and opposite (frequency domain: π phase shift−temporal domain: one balanced port signal is the opposite of the other balanced port signal). Baluns 208 are designed to equally split the energy of a signal fed to the unbalanced port between the two unbalanced ports, reciprocally baluns are able to combine at the unbalanced port a differential signal applied to the balanced ports. In the example shown in FIG. 2B, balun 208-1 splits source signal V_{S} applied to the unbalanced port 1, whereas balun 208-2 combines the differential signal applied to balanced ports 2 and 3. Receiver 209, which may relate to a radio transceiver, commonly possess only one unbalanced input/output port. To use balanced communication with common mode rejection, a balun with a sufficient CMRR may be required. In accordance with at least some embodiments of the present disclosure, it is to be appreciated that whilst a balun may relate to a hardware device, the functionality provided by the balun may also be provided by alternative means. In particular, and as is described in the below description of exemplary embodiments, the functionality of the balun 208 may be provided by the configuration of module antenna 109 and bus antenna 115 of FIG. 1. More specifically, and applying the principles of FIG. 2B to the battery system of FIG. 1, in accordance with at least some embodiments of the disclosure, when a signal is transferred from cell monitoring device 105 to BMS 101, electromagnetic coupling of module antenna 109 with bus antenna 115 provides the functionality of balun 208-1 of FIG. 2B, and radio transceiver 111 provides the functionality of balun 208-2. To achieve this, radio transceiver 111 at BMS 101 may be provided with a balun, or other subtractor devices, such as a differential amplifier. Further implementation details, in accordance with embodiments of the disclosure follow. Alternatively, bus antenna 115, may be bidirectional, i.e. a transmission signal may be transmitted from any of CMDs 105 to BMS 101, or from BMS 101 to any of CMDs 105. In this latter situation, CMD 105 corresponds to the receiver and radio transceiver 111 corresponds to the source, the electromagnetic coupling of module antenna 109 with bus antenna 115 provides the functionality of balun 208-2 of FIG. 2B, and radio transceiver 111 provides the functionality of balun 208-1. To achieve this, radio transceiver 111 at BMS 101 may be provided with a block that provides a differential output, such as a splitter inverter, a differential output amplifier, or a balun.

### NFC Communication Assembly

Returning to FIG. 1, and in accordance with embodiments of the present disclosure, an assembly comprising bus antenna 115 and module antenna 109, adopting near-field communication is provided. The assembly enables communication with BMS 101, and specifically between at least one electronic device 107 of a respective CMD 105 and radio transceiver 111 of BMS 101. Such an assembly addresses both the high-voltage (HV) isolation and EMI issues simultaneously. Another advantage of near-field coupling is that the value of the coupling strength may easily be adjusted to achieve weak coupling. The weak coupling may be set so as not to overload bus antenna 115. Use of weak coupling is advantageous in that it enables a large number of CMDs 105 (e.g. N>200) to be spaced along bus antenna 115, without overloading it or changing its characteristics. Module antenna 109 may be operatively coupled to electronic device 107, and bus antenna 115 may be configured for operative communication with radio transceiver 111. Module antenna 109 and bus antenna 115 are arranged with respect to each other to enable near-field coupling there between when a transmission signal is input into either module antenna 109 or bus antenna 115. In other words, the herein disclosed assembly enables two-way communication between CMD 105 and BMS 101. Within the present context, a transmission signal may correspond to an electrical signal characterized by at least one of voltage, current, power, frequency of wavelength. For example, the transmission signal may, in some non-limiting embodiments, correspond to a radio wave having a frequency between 2.4 and 2.5 GHz, although, and as should be clear from the preceding description, this frequency range is by no means limiting, and any desired frequency may be selected, and more specifically any desired ISM band may be used.

As shown in FIG. 1, bus antenna 115 may comprise at least two transmission lines 115-1 and 115-2. A transmission line may refer more generically to any elongated conductor enabling the transmission of a signal; thus, examples of transmission lines may include a cable, a wire, a cable from a twisted pair or a microstrip. In accordance with some embodiments, bus antenna 115 may comprise more than two transmissions lines. Thus, for present purposes, whilst the remaining embodiments are described with respect to a bus antenna having two transmission lines, it is to be appreciated that the bus antenna may comprise more than two transmission lines. In such embodiments, it is envisaged that the one or more additional transmission lines have a different, negligible or no near-field coupling strength with module antenna 109 (e.g., a ground line). In accordance with some embodiments, bus antenna 115 may also include termination 117 (FIG. 1), that may be located at one end of bus antenna 115 opposite the end radio transceiver 111 (as shown in FIG. 1) is connected to. Bus antenna 115 may be configured such that, substantially all of the energy in the transmission line that is not coupled to module antennas 109, is absorbed by termination 117. Termination 117 may include any electrical device configured to match a characteristic impedance of the two transmission lines 115-1/2, such as a resistor. According to some embodiments, and as described in the preceding section, the two transmission lines 115-1, and 115-2 of bus antenna 115 may be configured as a balanced circuit, such that an electrical signal propagating in a first one of the two transmission lines is π radians out of phase with respect to an electrical signal propagating in a second one of the transmission lines.

In some embodiments, and as previously stated, module antenna 109 and bus antenna 115 may form a balun in operation. In this scenario, the transmission signal may comprise an unbalanced electrical signal input to module antenna 109, which is output as a balanced electrical signal at bus antenna 115. This is the scenario when a transmission signal is being transmitted from module antenna 109 to bus antenna 115. Where instead a transmission signal is being sent from bus antenna 115 to module antenna 109, the transmission signal may comprise a balanced electrical signal input to bus antenna 115, which is output as an unbalanced electrical signal at module antenna 109. In this situation, advantageously, EMI immunity is reinforced by common mode rejection.

### Assembly Architecture

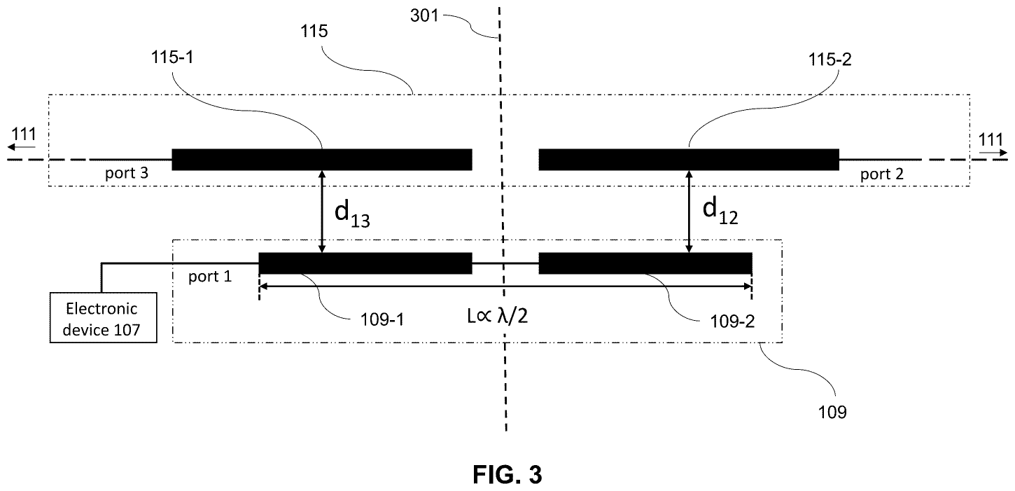

Now that the principles of operation of the present disclosure have been provided, more specific details of the assembly architecture are provided. FIG. 3 represent a schematic illustration of an exemplary bus/module antenna assembly, consistent with the disclosed embodiments. Module antenna 109 comprises a transmission line having a first 109-1 and a second 109-2 section arranged in series forming an unbalanced electrical path. First 109-1 and second 109-2 sections are of equal electrical length, and a total path length of first 109-1 and second 109-2 sections is an integer multiple of half an operating wavelength λ of a carrier wave. In other words, the phase difference between a transmission signal at one end of module antenna 109 transmission line and its reflected wave is 2π. Within the context of this disclosure, a carrier wave refers to an electromagnetic waveform that may be modulated or manipulated to carry information. An example of a carrier wave may include a transmission signal input into either module antenna 109 or bus antenna 115. The electrical length is a measure of the phase shift experienced by a carrier wave as it travels through a transmission line, it corresponds to the physical length expressed in terms of the operating wavelength λ of the carrier wave modulo 2π. Accordingly, two different transmission lines or sections of a transmission line may have an equal electrical length but two different physical lengths (the physical lengths differ by an integer multiple of the operating wavelength). In the following sections, unless otherwise specified, the term length refers to the physical length. In accordance with some embodiments, first 109-1 and second 109-2 sections may have an electrical length equal to π/2, and a same length equal to λ/4. In accordance with some embodiments, the transmission line of the module antenna 109 may form an open circuit, as illustrated in FIG. 3 with one end (the one not connected to first section 109-1) of second section 109-2 of module antenna 109 transmission line being an open circuit. In accordance with some other embodiments, the transmission line of module antenna 109 may be shorted to ground. For example, the one end of second section 109-2 not connected to first section 109-1 may be shorted to ground. The purpose of forming an open circuit or shorting to ground one end of module antenna 109 transmission line is to reflect all the energy to the other end, the one end optionally connected to electronic device 107 as illustrated in FIG. 3. Although the present disclosure includes drawings with sections in the form of straight lines, it should be noted that the sections may adopt a curvilinear form or may be in the form of a meandering line.

As mentioned above, bus antenna 115 comprises at least two transmission lines 115-1 and 115-2. Each one of the transmission lines 115-1, 115-2 is spaced apart from and positioned adjacent to a different one of the first 109-1 and second 109-2 sections of the module antenna's 109 transmission line, to enable near-field coupling when a transmission signal is present in either the bus antenna 115 or the module antenna 109. In the context of the present disclosure, a section adjacent to a transmission line may refer to the section closest to the transmission line, for example as illustrated in FIG. 3, first section 109-1 is adjacent to transmission line 115-1, and second section 109-2 is adjacent to the transmission line 115-2. In accordance with some embodiments, each one of the transmission lines 155-1, 115-2 of bus antenna 115 may be positioned parallel to a different one of the first 109-1 and second 109-2 sections of module antenna 109 transmission line, as illustrated for example in FIG. 3.

Where module antenna 109 and bus antenna 115 form a balun in operation, the balanced ports (ports 2 and 3) are formed by the two transmission lines 115-1, 115-2, and transmissions lines 115-1 and 115-2 form a balanced circuit. The unbalanced port (port 1) is formed by module antenna's 109 transmission lines and is located at one of its ends. For example, as illustrated in FIG. 3, the unbalanced port (port 1) is located at one of the ends of first section 109-1, the one end not connected to second section 109-2. The level of balance between the two transmission lines 115-1, and 115-2 is related to the ability of the assembly to transmit an electrical signal in each transmission line 115-1, 115-2 with a substantially identical magnitude, although with a phase shift of π radians. In other words, the level of balance depends on the ability of the assembly to provide substantially the same coupling strength between each transmission line of the bus antenna and its adjacent section. Within the present context, two substantially identical magnitudes may refer to two values whose relative difference is less than a predetermined percentage. For example, two values of induced current may be substantially identical if they differ by less than 1% or 2%. The closer the magnitude of the electrical signal in each transmission line, the higher the level of balance and the better the CMRR of the balun formed by bus antenna 155 and module antenna 109. For example, according to some embodiments, the balance level between the two balanced ports may be configured to yield a CMRR greater than or equal to 0, 10 dB, 20 dB or more. The unbalanced port (port 1) may be operatively connected to electronic device 107 as illustrated in FIG. 3.

The near-field coupling strength between two transmission lines is the strength of the electromagnetic coupling that occurs between them due to their proximity and, more specifically, depends on the overlap between their respective electromagnetic modes. The degree of mode overlap depends on multiple factors such as the distance between the two transmission lines, the geometrical characteristics of the transmission lines (cross-section, radius, height, width . . . ) and the physical properties (dielectric permittivity, conductivity . . . ) of the material of the transmission lines and of the surrounding environment. It is difficult to find an exact analytical expression of the coupling as a function of these parameters, so to accurately determine the near-field coupling strength between two transmission lines, detailed electromagnetic analysis and modelling techniques, such as electromagnetic simulations or circuit simulations, are often employed. Without loss of generality, the magnitude of the electromagnetic field generated by a source decreases with the distance from the source, meaning that when the distance of separation between two transmission lines is small, the electromagnetic fields are more likely to interact and couple.

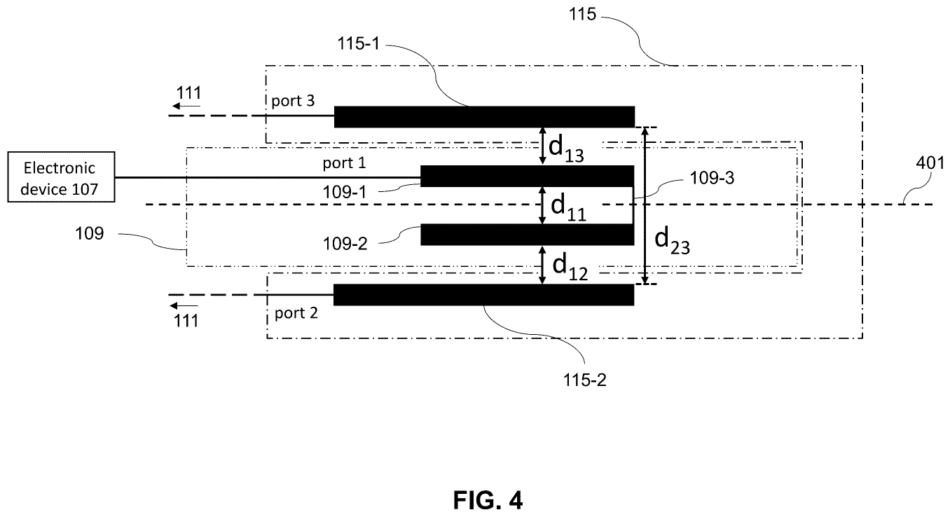

Accordingly, the near field coupling strength between bus antenna 115 and module antenna 109 depends on a distance of separation d between the transmission line of the module antenna and at least one of the transmission lines of the bus antenna, or more specifically a distance of separation d₁₂, d₁₃ between each of the bus antenna transmission lines 115-1, 115-2 and its adjacent section. Near-field coupling strength is expected to be greater as the distance of separation d decreases, therefore the distance of separation d may be selected to tune the value of the near-field coupling strength. In accordance with some embodiments, each one of bus antenna transmission lines 115-1, 115-2 may be located equidistant relative to a different one of sections 109-1, 109-2 of the transmission line of module antenna 109. For example, as illustrated in FIGS. 3-4, the distance of separation d₁₂ between first section 109-1 and transmission line 115-1, is substantially the same as the distance of separation d₁₃ between second coil 109-2 and transmission line 115-2. Notwithstanding the above, alternative embodiments are also envisaged in which each separation distance between bus antenna transmission lines 115-1, 115-2 and their adjacent section is different. In accordance with some embodiments, distance of separation d₁₂, d₁₃ between each one of the bus antenna transmission lines and its adjacent section may be selected to achieve a coupling strength greater than or equal to −50 dB, and less than or equal to −10 dB. Alternatively, distance of separation 303 may be selected to achieve a coupling strength greater than or equal to −40 dB, and less than or equal to −20 dB., or a coupling strength greater than or equal to −35 dB and less than or equal to −25 dB.

Distance of separation d₁₂, d₁₃ may also be selected as a function of a clearance/creepage distance. As a specific clearance/creepage distance is required to ensure a certain level of voltage isolation, a minimum distance of separation d₁₂, d₁₃ may be required. The differentiation between clearance and creepage distance depends on the nature of the material that separates each of the transmission lines of the bus antenna and its adjacent section. In accordance with some embodiments, each one of the bus antenna transmission lines and its adjacent coil may be separated by a dielectric insulating material. Examples of dielectric insulating material may include any one or more of: air, a plastic material, a glass-filled plastic material, an epoxy composite material, polyethylene terephthalate “PET”, acrylonitrile butadiene styrene “ABS”, polytetrafluoroethylene “PTFE”, polyvinyl chloride “PVC”, polybutylene terephthalate “PBT”, polyethylene “PE”, polyamide “PA”, FR4, ceramic-filled polytetrafluoroethylene “PTFE”, ceramic laminates, or mylar. In the example of FIG. 3 each bus antenna transmission line 115-1, 115-2 and its adjacent section are separated by air. In accordance with some embodiments, the dielectric insulating material may be selected to have a dielectric breakdown voltage greater than the operating voltage of the battery system. Dielectric breakdown voltage is the voltage at which a dielectric material undergoes a significant increase in its electrical conductivity, resulting in the breakdown of its insulating properties. For example, if the operating voltage V_{B} of a battery system is equal to 400 V, and the distance of separation between each one of the bus antenna transmission lines 115-1, 115-2 and its adjacent coil is 4 mm, a material with a dielectric breakdown voltage with a minimum breakdown voltage of 100 V/mm may be used to address the high voltage isolation issue. In practice, it is common to select a material with a dielectric breakdown voltage orders of magnitude greater than the required dielectric breakdown voltage. In the above example, it would be common to select a dielectric material having a dielectric breakdown voltage of several kV/mm, for added safety. Examples of such material are listed above, e.g., Mylar has a dielectric breakdown voltage equal to 7 kV/mm.

As mentioned above, the near-field coupling strength between two transmission lines depends on the geometric parameters of the transmission lines. First 109-1 and second 109-2 cross sections have a transverse profile defined by one or more characteristics dimensions. It should be noted that the transverse profile of a section may have any shape (square, rectangular, circle etc.). In accordance with some embodiments, first 109-1 and second 109-2 sections may share a same transverse profile as shown in FIG. 3. Similarly, each transmission line 115-1, 115-2 has a transverse profile. In accordance with some embodiments, bus antenna transmission lines 115-1, 115-2 may share the same transverse profile.

Each of the aforementioned parameters (transverse profiles, distances of separations d₁₂, d₁₃) has a direct impact on the value of the near-field coupling strength between each bus antenna transmission lines 115-1, 115-2 and its adjacent coil. It should be appreciated that by carefully varying these parameters, it may be possible to obtain a constant near-field coupling strength. Furthermore, two transmission line/section couples may present the same near-field coupling strength, even if they are separated by different distances or have different characteristic parameters. For example, if a transmission line/section pair is separated by a first spacing distance and a second transmission line/section pair is separated by a second spacing distance greater than the first, a same near-field coupling strength may be achieved for the second pair by adjusting the one or more characteristic dimensions of the transmission line or section transverse profile.

### Implementations of the Assembly

Different implementations are envisaged for the bus/module antenna. FIG. 4 represents a schematic illustration of an exemplary bus/module antenna assembly, consistent with the disclosed embodiments. In accordance with some embodiments, the transmission line of module antenna 109 may be U-shaped, in which case first 109-1 and second 19-2 sections are arranged parallel to each other and are connected by a bottom section 109-3, as illustrated in FIG. 4 for example. Bottom section 109-3 may share with first 109-1 and second 109-2 sections at least one of the following characteristics a same transverse profile. Alternatively, the transverse profile of bottom section 109-3 may be different from the ones of first 109-1 and second 109-2 sections. For example, the transverse profile of bottom 109-3 may differ from the transverse profile of first 109-1 and second 109-2 sections.

The electrical length of bottom section 109-3 may be selected such that a carrier wave enters and leaves the bottom section with substantially the same phase and provided that a total path length of module antenna 109 transmission line (first 109-1, second 109-2 and bottom 109-3) sections is an integer-multiple of half an operating wavelength of the carrier wave. In other words, in some embodiments, the electrical length of bottom section 109-3 is negligible with respect to the electrical length of first 109-1 and second 109-2 sections or alternatively where it is not negligible it needs to be accommodated in the total path length of module antenna 109 transmission line.

In accordance with some embodiments, the length of bottom section 109-3 d₁₁ may be equal to the distance of separation d₂₃ of bus antenna 115 transmission lines 115-1, 115-2, such that the distance of separation between the two sections of module antenna 109 transmission line may be equal to the distance of separation between bus antenna 115 transmission lines 115-1, 115-2. Referring to FIG. 4, this would imply that d₁₁=d₂₃, in this configuration, the bus antenna 115 and the module antenna 107 would be in different parallel planes, and the distance of separation between the two parallel planes would correspond to the distance of separation d between module antenna 109 transmission line and bus antenna 115 transmission lines 115-1, 115-2. Accordingly, the distance of separation between the two parallel planes could be selected to adjust the near-field coupling strength and satisfy the high voltage isolation requirement. In accordance with some other embodiments, the length of bottom section 109-3 d₁₁ may be less than the distance of separation d₂₃ between bus antenna 115 transmission lines 115-1, 115-2, such that the distance of separation d₁₁ between the two sections of module antenna 109 is less than the distance of separation d₂₃ between bus antenna 115 transmission lines 115-1, 115-2, as illustrated for example in FIG. 4, where d₁₁<d₂₃. Alternatively, the length of the bottom section 109-3 d₁₁ may be greater than the distance of separation d₂₃ between bus antenna 115 transmission lines 115-1, 115-2, such that the distance of separation d₁₁ between the two sections of module antenna 109 is greater than the distance of separation d₂₃ between bus antenna 115 transmission lines 115-1, 115-2. Referring to FIG. 4, this would imply that d₁₁>d₂₃, in this configuration bus antenna 115 would be spatially surrounded by module antenna 109 first 109-1 and second 109-2 sections.

In yet a further embodiment, it is envisaged that the transmission line of the module antenna may be shaped as an open loop. An open loop refers to any geometric patterns or shapes that are not closed or connected. Optionally module antenna 109 may be elliptical in shape, comprising an open end.

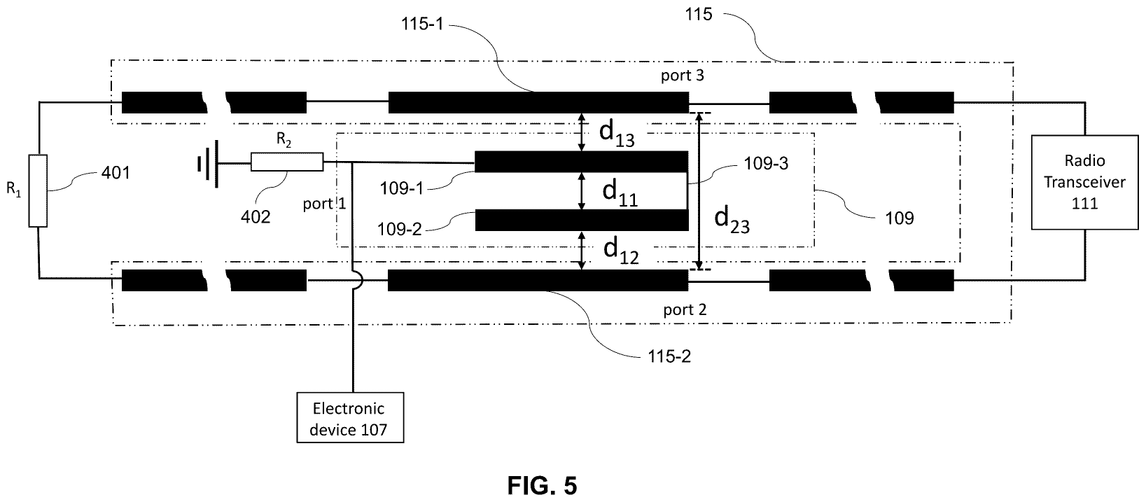

FIG. 5 represents a schematic illustration of another exemplary bus/module antenna assembly, consistent with the disclosed embodiments. In this figure, the transmission lines 115-1 and 115-2 of bus antenna 115 are shown more completely and are connected at one end to the termination resistor R₁ 401, and to the radio transceiver 111 at the other end. In accordance with some embodiments, the transmission line of module antenna 109 may be connected to a termination resistor. For example, as illustrated in FIG. 5, first section 109-1 of module antenna 109 transmission line is connected to termination resistor R₂ 402. The value of termination resistor R₂ 402 may be selected to absorb all incident or all reflected energy at port 1.

### Assembly Symmetries

In accordance with some embodiments, the position of the bus antenna 115 transmission lines 115-1, 115-2 relative to first 109-1 and second 109-2 sections of the module antenna 109, may be symmetrical about a plane of symmetry extending along an axis in a direction parallel to a length of the bus antenna transmission lines and along an axis in a direction parallel to a height of the bus antenna transmission lines. For example, as illustrated in FIG. 4, the position of the bus antenna 115 transmission lines 115-1, 115-2 relative to first 109-1 and second 109-2 sections of the module antenna 109 is symmetric about plane 401.

Alternatively, in some other embodiments, the position of the bus antenna 115 transmission lines 115-1, 115-2 relative to first 109-1 and second 109-2 sections of module antenna, may be symmetrical about an axis of symmetry comprised in a cross-sectional plane formed perpendicular to the length of the first and second sections of the module antenna transmission line. For example, as illustrated in FIG. 3, the position of the bus antenna 115 transmission lines 115-1, 115-2 relative to first 109-1 and second 109-2 sections of the module antenna 109 is symmetric about axis 301.

### Printed Circuit Board Implementation

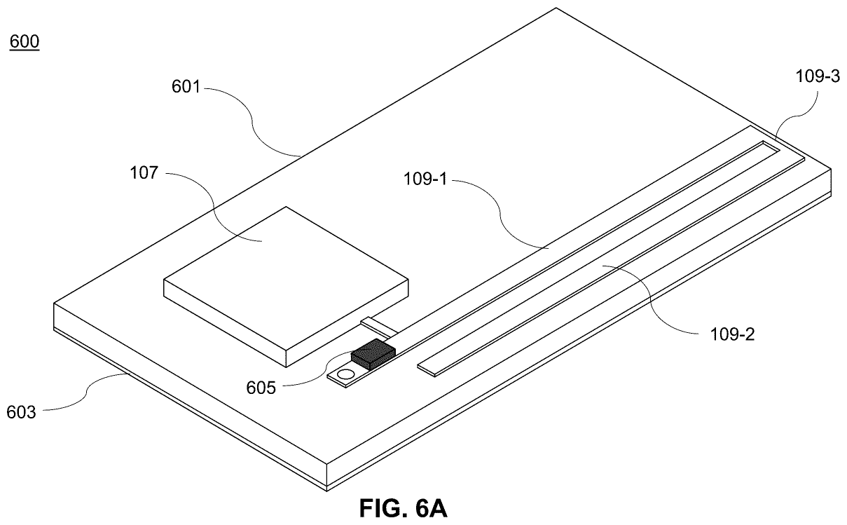

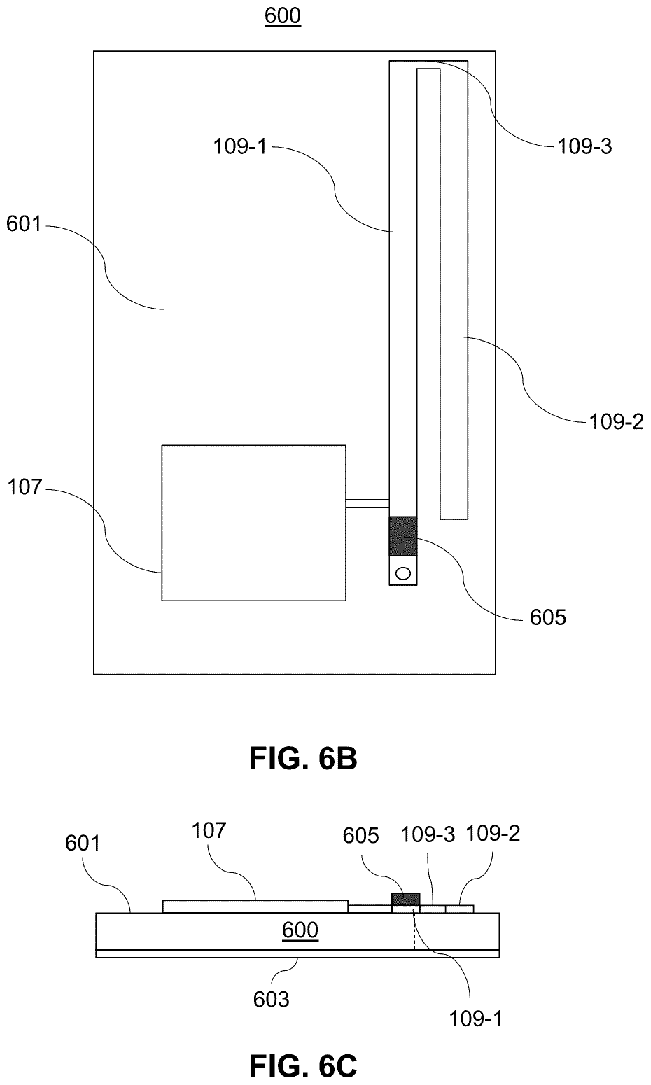

In accordance with some embodiments, the assembly comprising bus antenna 115 and module antenna 109 may comprise a printed circuit board (PCB). In accordance with some embodiments, the PCB may comprise electronic device 107 and module antenna 109. FIGS. 6A-C represent respectively a perspective, a top and a side view of a PCB 600 comprising module antenna 109 and electronic device 107 consistent with the disclosed embodiments. In these figures, module antenna 109 is U shaped and comprises first 109-1, second 109-2 and bottom sections 109-3. Optionally, module antenna 109 may be embedded within a layer of the PCB. In accordance with some embodiments, PCB 600 may comprise a plurality of layers 601 and a ground plane 603, the ground plane 603 being embedded in a different layer of the PCB than the layer 607 the module antenna 109 is embedded in. For example, as illustrated in FIGS. 6A-C, PCB 600 consist of two layers 601, 603, the ground plane 603 being located on the bottom layer. First section 109-1 is connected to termination resistor 605, and ground connection of termination resistor 605 is made through a via connecting termination resistor 605 to ground plane 603.

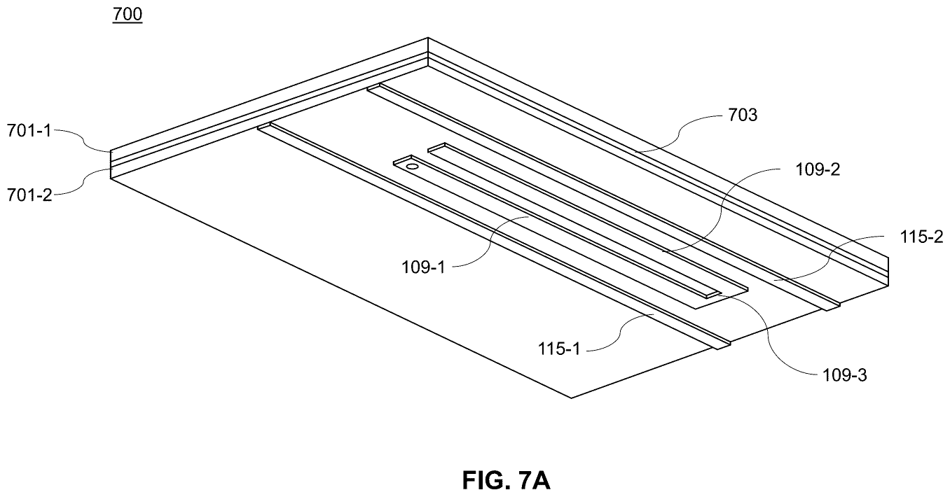

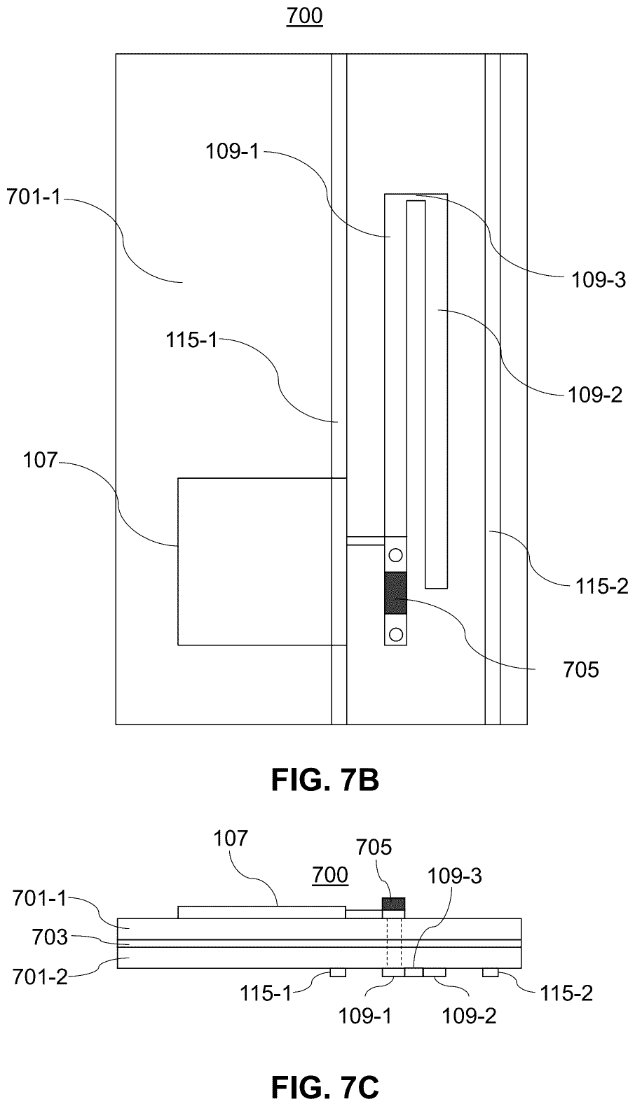

In accordance with some embodiments, PCB may also comprise bus antenna 115 along with module antenna 109 and electronic device 107. In such embodiments, it is envisaged that the PCBs affixed to neighbouring battery modules 103 are electrically connected, to ensure that bus antenna 115 transmission lines 115-1, 115-2 form a continuous electrical path across all battery modules 103 in the battery system. Optionally, bus antenna 115 may fixated to an exterior surface of the PCB. This configuration is shown in FIGS. 7A-C representing respectively a perspective, a top and a side view of a PCB 700 comprising module antenna 109 electronic device 107, and bus antenna 115, and wherein module antenna 109 and bus antenna 115 are fixated to an exterior surface of PCB 700. As for FIGS. 6A-C, module antenna 109 is U-shaped. PCB 700 comprises a plurality of layers 701-1, 701-2 and a ground plane 703, the ground plane 703 being sandwiched between first 701-1 and second layer 701-2 of PCB 700. First section 109-1 is connected to termination resistor 705, and ground connection of termination resistor 705 is made through a via connecting termination resistor 705 to ground plane 703.

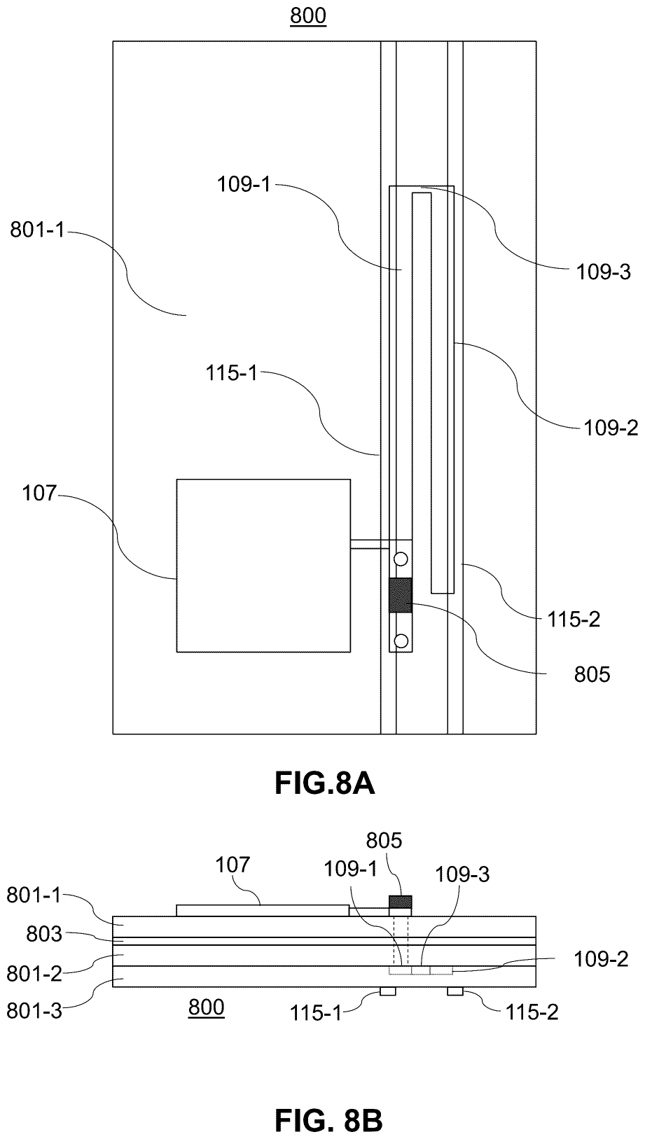

In some other embodiments, the PCB may comprise a plurality of layers, and bus antenna 115 may be fixated to or embedded in a different layer of the PCB than the layer the module antenna is embedded in. FIGS. 8A-B illustrate respectively a top and a side view of a PCB 800 comprising module antenna 109 electronic device 107, and bus antenna 115, and wherein module antenna 109 is embedded within a layer 801-3 of PCB 800 and bus antenna 115 fixated to the bottom surface of PCB 800. As for FIGS. 6A-7C, module antenna 109 is U-shaped. PCB 800 comprises a plurality of layers 801-1, 801-2, 801-3 and a ground plane 803 the ground plane 803 being sandwiched between first 801-1 and second layer 801-2. First section 109-1 is connected to termination resistor 805, and ground connection of termination resistor 805 is made through a blind via connecting termination resistor 805 to ground plane 803. By varying the thickness of the third layer 801-3 of PCB 800 the near-field coupling strength may be tuned. In this embodiment, the creepage distance corresponds to the distance along the PCB 800 surface from bus antenna 115 transmission lines 115-1, 115-2 on the bottom surface around the edge of PCB 800 and along the top surface to the connections to the chip.

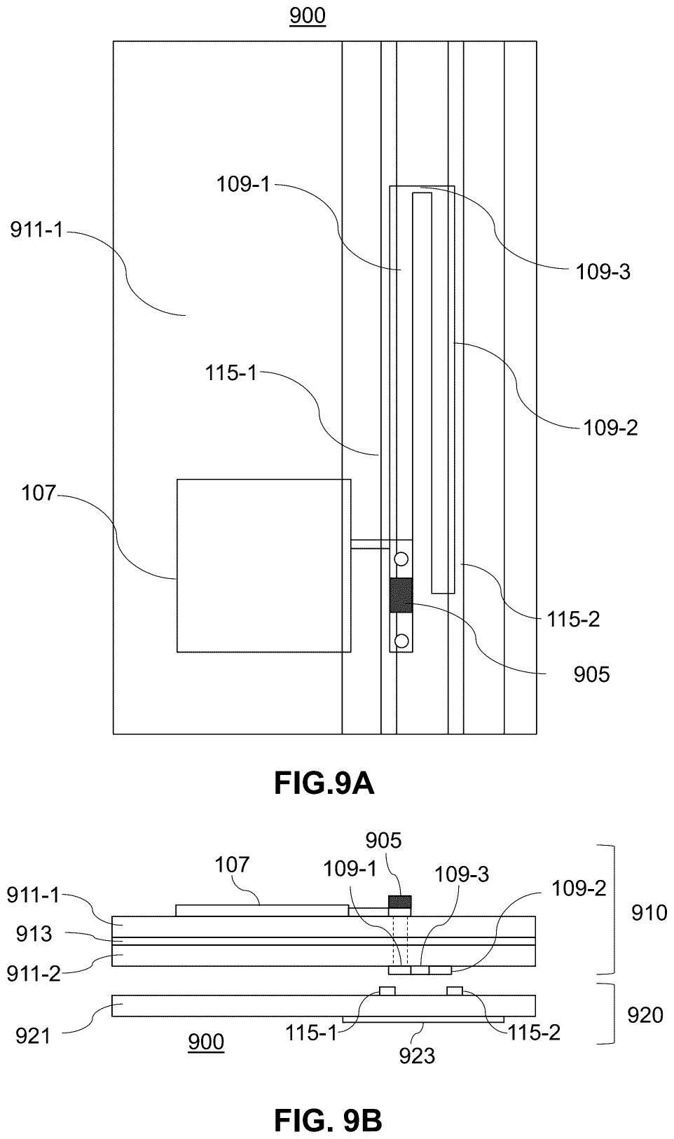

In some further embodiments, bus antenna 115 may be included in a PCB different from the PCB comprising module antenna 109 and electronic device 107, the two PCB being parallel and separated by an air gap. This embodiment is shown in FIGS. 9A-B representing respectively a top and a side view of a couple of PCBs 900 separated by an air gap. First PCB 910 is comprising module antenna 109 and electronic device 107, second PCB 920 is comprising bus antenna 115. As for FIGS. 6A-8B, module antenna 109 is U-shaped. First PCB 910 comprises a plurality of layers 911-1, 911-2 and a ground plane 913, the ground plane 913 being sandwiched between first 911-1 and second layer 911-2 of PCB 910. First section 109-1 is connected to termination resistor 905, and ground connection of termination resistor 905 is made through a via connecting termination resistor 905 to ground plane 913. Second PCB 920 comprises first layer 921 and ground plane 923. By varying the air gap between first 910 and second 920 PCBs the near-field coupling strength may be tuned. Optionally, the gap between the two PCBs may be filled with an insulating material, such as polyester, ABS, FEP, or PFTE, in order to further increase the high voltage insulation.

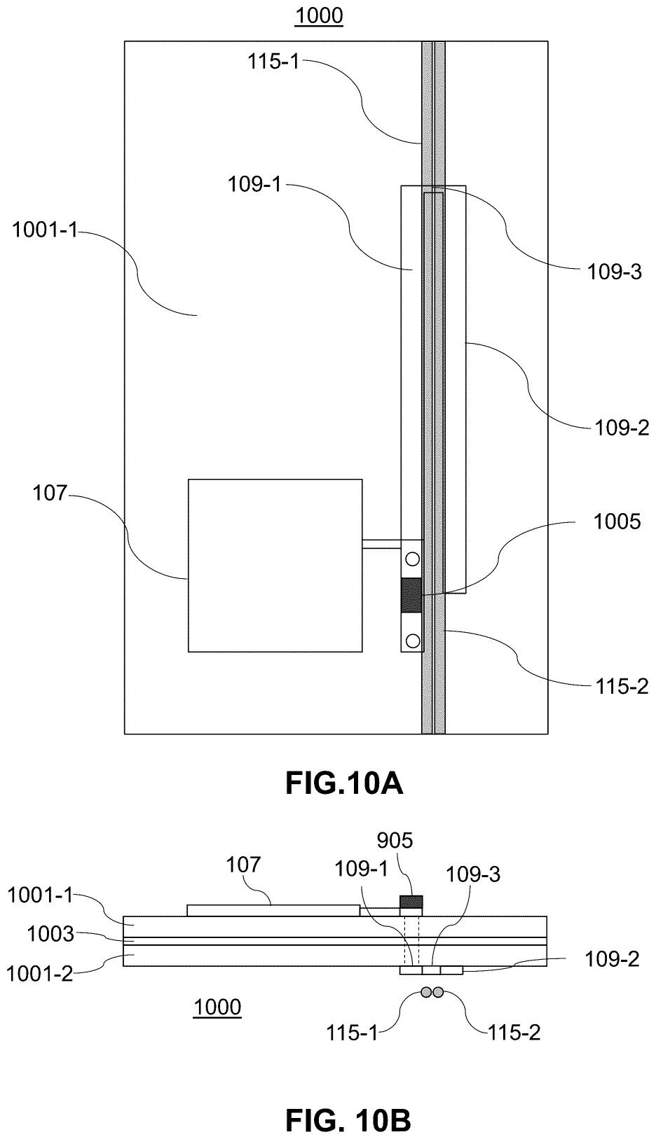

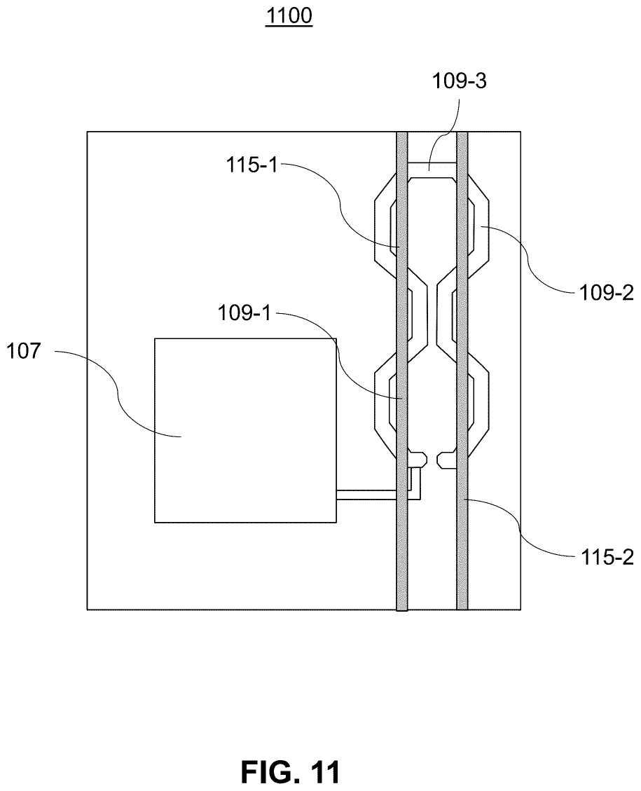

In some alternative embodiments, bus antenna 115 may comprise a cable located external to the PCB, and optionally the cable may be any one of: a twin core cable, a multi-core cable, a ribbon cable. This embodiment is shown in FIGS. 10A-B representing respectively a top and a side view of a PCB 1000 and external bus antenna 115. PCB 1000 is comprising module antenna 109 and electronic device 107. As for FIGS. 6A-9B, module antenna 109 is U-shaped. PCB 1000 comprises a plurality of layers 1001-1, 1001-2 and a ground plane 1003, the ground plane 1003 being sandwiched between first 1001-1 and second layer 1001-2 of PCB 1000. First section 109-1 is connect to termination resistor 1005, and ground connection of termination resistor 1005 is made through a via connecting termination resistor 1005 to ground plane 1003. By varying the distance between bus antenna 115 and the bottom surface of PCB 1000 the near-field coupling strength may be tuned. Additionally, PCB 1000 may comprise at least one fastener for affixing bus antenna 115 transmission lines 115-1, 115-2 to the PCB 1000 at a distance of separation relative to the module antenna. FIG. 11 is a top view of a PCB 1100 and external bus antenna 115. In this figure, module antenna 109 transmission line takes the shape of an open hourglass, e.g., “O=O” or four horseshoes, first 109-1 and second 109-2 sections of module antenna 109 transmission line adopt the form of meandering lines, and are of equal electrical length and physical length. This configuration offers improvement in the overall compactness of the module antenna 109 transmission line, at the cost of a small reduction in the near-field coupling strength. It is to be appreciated that the first 109-1 and second 109-2 sections do not have to be linear, and non-linear shaped first 109-1 and second 109-2 sections are envisaged. The first 109-1 and second 109-2 non-linear sections illustrated in FIG. 11 are non-limiting examples, and other non-linear-shaped sections may be provided for. For example, elliptical, oval, hexagonal, polygonal, or any other shapes are envisaged. Another advantage of the module antenna 109 shape shown in FIG. 11 is that whilst the length of the module antenna is reduced, compared to its straight-sectioned predecessors (as shown in FIGS. 6A-9B), its width is increased providing a higher misalignment tolerance of module antenna 109 relative to bus antenna 115.

In any of the above-described PCB embodiments, the geometry of the PCB is selected such that the minimum clearance/passage distance required to ensure a specific level of voltage isolation is satisfied.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives or equivalents to the provided embodiments. The examples discussed herein were chosen and described in order to explain the principles and the nature of various example embodiments, and their practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same or functionally equivalent item of hardware.

The various example embodiments described herein are described in the general context of method steps or processes, which may be implemented in one aspect by a computer program product, embodied in a computer-readable medium or a non-transitory computer-readable medium, comprising computer-executable instructions, such as program code, executed by computers or one or more processors in networked environments. A computer-readable medium or a non-transitory computer readable medium may comprise removable and non-removable storage devices comprising, but not limited to, Read Only Memory (ROM), Random Access Memory (RAM), compact discs (CDs), digital versatile discs (DVD), flash memories, etc. Generally, program modules may comprise routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specifications, there have been disclosed example embodiments. However, many variations and modifications can be made to these embodiments. Accordingly, although specific terms are employed, they are used in a generic and descriptive sense only and not for purposes of limitation, the scope of the embodiments being defined by the following claims.

1. An assembly for use with a battery pack comprising a plurality of battery cells, the assembly for enabling communication between an electronic device and a radio transceiver located remotely from the electronic device, the assembly comprising:
a module antenna operatively connected to the electronic device, the module antenna comprising a transmission line having a first and a second section arranged in series forming an unbalanced electrical path, the first and second sections being of equal electrical length, and a total path length of the first and second sections is an integer-multiple of half an operating wavelength of a carrier wave;
a bus antenna configured for operative communication with the radio transceiver, the bus antenna comprising at least two transmission lines, each transmission line being greater in length than either the first or second section of the module antenna, and each one of the transmission lines being spaced apart from and positioned adjacent to a different one of the first and second sections of the module antenna's transmission line, to enable near-field coupling between the module antenna and the bus antenna when a transmission signal is input into either the module antenna or the bus antenna.

2. The assembly of claim 1, wherein the total path length of the first and second sections of the module antenna transmission line is half an operating wavelength of the carrier wave.

3. The assembly of claim 1 or 2, wherein in operation the module antenna and the bus antenna form a balun, and wherein when the transmission signal comprises an unbalanced electrical signal input in the module antenna, it is output as a balanced electrical signal in the bus antenna; or, when the transmission signal comprises a balanced electrical signal input in the bus antenna, it is output as an unbalanced electrical signal in the module antenna.

4. The assembly of any one of claims 1 to 3, wherein each one of the transmission lines of the bus antenna is positioned parallel to a different one of the first and second sections of the module antenna transmission line.

5. The assembly of any preceding claim, wherein each one of the bus antenna transmission lines is located equidistant relative to a different section of the module antenna.

6. The assembly of any preceding claim, wherein the position of the bus antenna transmission lines relative to the first and second sections of the module antenna, is symmetrical about a plane of symmetry extending along an axis in a direction parallel to a length of the bus antenna transmission lines and along an axis in a direction parallel to a height of the bus antenna transmission lines.

7. The assembly of any preceding claim, wherein the position of the bus antenna transmission lines relative to the first and second sections of the module antenna, is symmetrical about an axis of symmetry comprised in a cross-sectional plane formed perpendicular to the length of the first and second sections of the module antenna transmission line.

8. The assembly of any one of claims 5 to 7, wherein the at least two transmission lines of the bus antenna are configured as a balanced circuit, such that an electrical signal propagating in a first one of the two transmission lines is a radians out of phase with respect to an electrical signal propagating in a second one of the transmission lines.

9. The assembly of any preceding claim, wherein the transmission line of the module antenna is U-shaped, the first and second sections are arranged parallel to each other and are connected by a bottom section.

10. The assembly of claim 9, wherein a length of the bottom section is equal to the distance of separation of the bus antenna transmission lines, such that the distance of separation between the two sections of the module antenna is equal to the distance of separation between the bus antenna transmission lines.

11. The assembly of claim 9, wherein either:
a length of the bottom section is less than the distance of separation between the bus antenna transmission lines, such that the distance of separation between the two sections of the module antenna is less than the distance of separation between the bus antenna transmission lines; or
a length of the bottom branch is greater than the distance of separation between the bus antenna transmission lines, such that the distance of separation between the two sections of the module antenna is greater than the distance of separation between the bus antenna transmission lines.

12. The assembly of any one of claims 1 to 8, wherein the transmission line of the module antenna is shaped as an open loop.

13. The assembly of claim 12, wherein the module antenna is elliptical in shape, comprising an open end.

14. The assembly of any preceding claim, wherein the transmission line of the module antenna is connected to a termination resistor.

15. The assembly of any preceding claim, wherein the transmission line of the module antenna forms an open circuit.

16. The assembly of any one of claims 1-14, wherein the transmission line of the module antenna is shorted to ground.

17. The assembly of any preceding claim, wherein each transmission line of the bus antenna is connected at one end to a termination resistor.

18. The assembly of claim 14 or 17, wherein the electrical resistance of the termination resistor is selected to match the characteristic impedance of the transmission line it is connected to.

19. The assembly of any preceding claim, wherein a distance of separation between each one of the bus antenna transmission lines and its adjacent section of the module antenna's transmission line is selected to achieve a coupling strength greater than or equal to −50 dB, and less than or equal to −10 dB.

20. The assembly of claim 19, wherein the distance of separation between each one of the bus antenna transmission lines and its adjacent section of the module antenna's transmission line is selected to achieve a coupling strength greater than or equal to −40 dB, and less than or equal to −20 dB.

21. The assembly of claim 19 or 20 wherein the distance of separation between each one of the bus antenna transmission lines and its adjacent section of the module antenna's transmission line is selected to achieve a coupling strength of −30 dB.

22. The assembly of any preceding claim, wherein each one of the bus antenna transmission lines and its adjacent section of the module antenna's transmission line is separated by a dielectric insulating material.

23. The assembly of claim 22, wherein the dielectric material has a dielectric breakdown voltage greater than a working voltage of the battery pack.

24. The assembly of claim 22 or 23, wherein the dielectric insulating material comprises any one of: air, a plastic material, a glass-filled plastic material, an epoxy composite material.

25. The assembly of claim 22, wherein the dielectric insulating material comprises any one of: polyethylene terephthalate “PET”, acrylonitrile butadiene styrene “ABS”, polytetrafluoroethylene “PTFE”, polyvinyl chloride “PVC”, polybutylene terephthalate “PBT”, polyethylene “PE”, polyamide “PA”.

26. The assembly of claim 22, wherein the dielectric insulating material comprises any one of: FR4, ceramic-filled polytetrafluoroethylene “PTFE”, ceramic laminates, mylar.

27. The assembly of any preceding claim, comprising a printed circuit board “PCB” comprising the electronic device, and wherein:
the PCB comprises the module antenna.

28. The assembly of claim 27, wherein the module antenna is embedded within a layer of the PCB.

29. The assembly of claim 28, wherein the PCB comprises a plurality of layers and a ground plane, the ground plane being embedded in a different layer of the PCB than the layer the module antenna is embedded in.

30. The assembly of claim 28 or 29, wherein the PCB comprises a plurality of layers, and the bus antenna is embedded in a different layer of the PCB than the layer the module antenna is embedded in.

31. The assembly of claim 27 or 28, wherein the bus antenna is fixated to an exterior surface of the PCB.

32. The assembly of claim 27 or 28, wherein the bus antenna comprises a cable located external to the PCB.

33. The assembly of claim 32, wherein the cable is any one of: a twin core cable, a multi-core cable, a ribbon cable.

34. The assembly of any one of claims 27 to 29, and 31 to 33, wherein the PCB comprises at least one fastener for affixing the bus antenna transmission lines to the PCB at a distance of separation relative to the module antenna.

35. A battery cell comprising the assembly of any preceding claim.

36. A battery pack having a plurality of battery cells and comprising the assembly of any one of claims 1 to 34, wherein each battery cell is associated with an electronic device and the assembly enables communication between each electronic device and a radio transceiver located remotely from the battery pack via the bus antenna and the module antenna.
